(19) United States
(12) Patent Application Publication
(10) Pub. No.: US 2016/0295511 A1
(43) Pub. Date: Oct. 6, 2016

(54) REMOTE WAKEUP FOR WI-FI DEVICES

(71) Applicant: INTEL CORPORATION, Santa Clara, CA (US)

(72) Inventors: Emily H. Qi, Camas, WA (US); Carlos Cordeiro, Portland, OR (US); Ganesh Venkatesan, Hillsboro, OR (US); David J. McCall, Dallas, TX (US)

(21) Appl. No.: 15/026,840

(22) PCT Filed: Sep. 23, 2014
(86) PCT No.: PCT/US2014/057008

§ 371 Date: Apr. 1, 2016

Related U.S. Application Data
(60) Provisional application No. 61/916,395, filed on Dec. 16, 2013.

(51) Int. Cl. H04W 52/02; H04W 48/16; H04W 40/24; H04L 29/08; H04W 56/00

(52) U.S. Cl. CPC H04W 52/0229; H04W 52/0216; H04L 67/104; H04W 56/001; H04W 40/244; H04W 48/16; H04W 84/12

(57) ABSTRACT

Disclosed herein are techniques to enable remote wakeup of controlled devices. In particular, a controlling device and a controlled device may each power on a radio during a wakeup window. The controlling device may communicate a wakeup frame to the controlled device during the wakeup window to wake the controlled device from a sleep or low power state for purposes of communicating with the controlled device in a network, such as a peer-to-peer network.

### RELATED CASES

This application claims the benefit of U.S. Provisional Application Ser. No. 61/916,395 filed Dec. 16, 2013, entitled “Wi-Fi Device and Method to Wake Up Controlling Devices,” which application is incorporated herein by reference in its entirety.

### TECHNICAL FIELD

Embodiments described herein generally relate to wireless communications and in particular to Wi-Fi Direct Services.

### BACKGROUND

Many modern devices include wireless networking capabilities. In particular, many devices include various communication and networking abilities that provide for a direct connection between two or more devices. For example, devices (e.g., smart phones, tablet computers, or the like) are able to directly connect to devices (e.g., TVs, DVD players, game consoles, thermostats, home appliances, or the like) to remotely control the connected device. However, there is no standardized technique or methodology for controlling such devices. In particular, there is no standardized technique or procedure to wake up a device when the device is “sleeping” or in a power save state.

### BRIEF DESCRIPTION OF THE DRAWINGS

FIG. 1 illustrates one embodiment of a peer-to-peer network.

FIGS. 2-3 illustrate logic flows for embodiments of remotely waking a device.

FIG. 4 illustrates one embodiment of a remote wakeup technique.

FIG. 5 illustrates one embodiment of a storage medium.

FIG. 6 illustrates one embodiment of a device.

FIG. 7 illustrates one embodiment of a wireless network.

### DETAILED DESCRIPTION

The present disclosure is generally directed to providing remote wakeup procedures for wireless devices. Said differently, the present disclosure provides procedures for the establishment of a wake up window for a controlling device to wake a controlled device from a sleep or low power state in order to allow communication over a peer-to-peer (P2P) network. In some examples, the controlling device and one or more directly connected devices align their wake schedules with the wakeup window. Accordingly, each device can wake up based on the wake up window to allow for communication over the P2P connection. More specifically, each device may power on a radio in order to allow for communication related to exiting a low power state.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

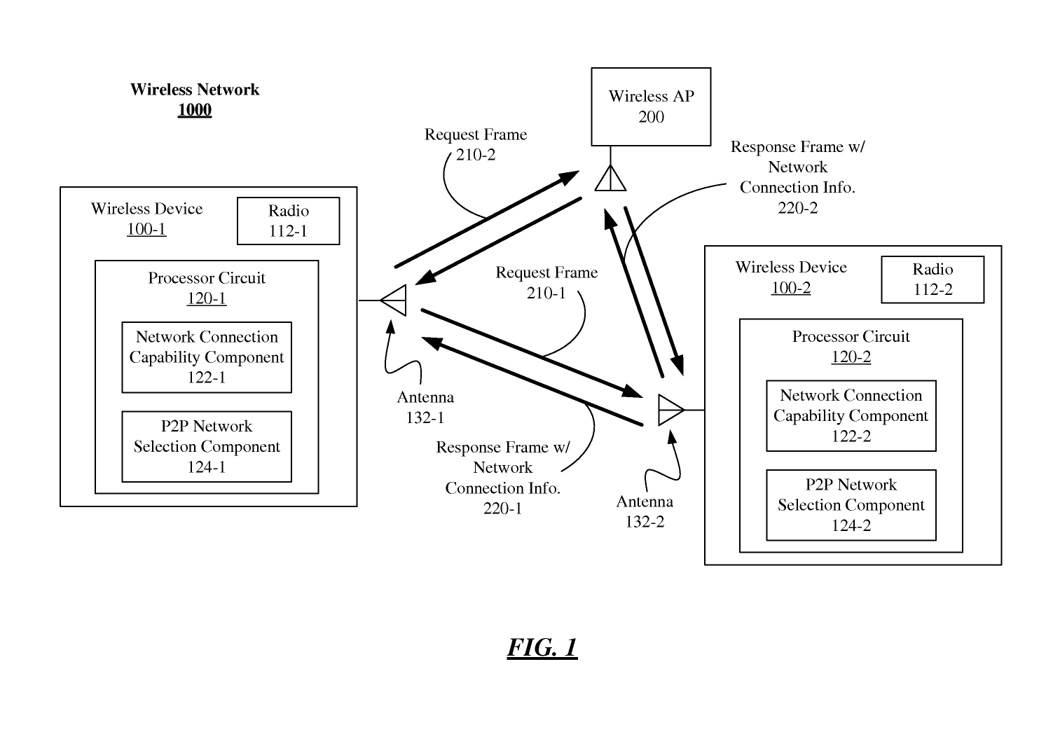

FIG. 1 illustrates a Wi-Fi network 1000. The network 1000 includes devices 100-a, where “a” is a positive integer. In particular, devices 100-1 and 100-2 are shown. However, it is to be appreciated, that any number of devices 100-a may be implemented, and the number of devices depicted is merely shown at a quantity to facilitate understanding. It is important to note, that the device 100-1 is referred to herein as the controlling device while the device 100-2 is referred to as the controlled device. During operation, the controlling device 100-1 is configured to wakeup the controlled device 100-2 for purposes of communicating in the P2P network 1100. However, reference to the device 100-1 as the controlling device and the device 100-2 as the controlled device is done for purposes of clarity only and is not intended to be limiting.

In general, the devices 100-a may be any computing device and/or communication device, such as, for example, smart phones, tablet computers, laptop computers, ultrabook computers, desktop computers, televisions, media streaming devices, game consoles, Internet connected televisions, DVD players, smart watches, or the like. In a particularly illustrative example, the controlling device 100-1 may be a smartphone while the controlled device 100-2 may be an

Internet connected television.

Each of the devices 100-a includes a radio 112-a. In general, the radios 112-a may be any radio configured to communicate wirelessly, such as, for example, Wi-Fi, WiGig, Bluetooth, ZigBee, or the like. In a particularly illustrative example, the radios 112-a may be Wi-Fi radios configured to communicate in a Wi-Fi network.

Furthermore, each of the devices 100-a includes an antenna (or antenna array) 132-a. Additionally, each of the devices 100-a includes a processor circuit 120-a operably coupled to the radio 112-a. In some examples, the processor circuit 120-a may be an application processor of the device 100-a. In some examples, the processor circuit 120-a may be a baseband processor of the device 100-a. Each of the devices 100-a may also include a radio wakeup component 122-a and a remote wakeup component 124-a.

The radio wakeup component 122-a and the remote wakeup component 124-a may comprise programming, functions, logic, parameters, and/or other information operative to implement particular capabilities for the devices 100-a. In some examples, the components 122-a and 124-a may be executable by the processing circuit 120-a.

Furthermore, the Wi-Fi network 1000 may include a Wi-Fi access point 1001. It is to be appreciated, that the Wi-Fi access point may be any of a variety of access points (e.g., router, range extended, base station, or the like) configured to facilitate access to the Wi-Fi network 1000 and/or the Internet (not shown).

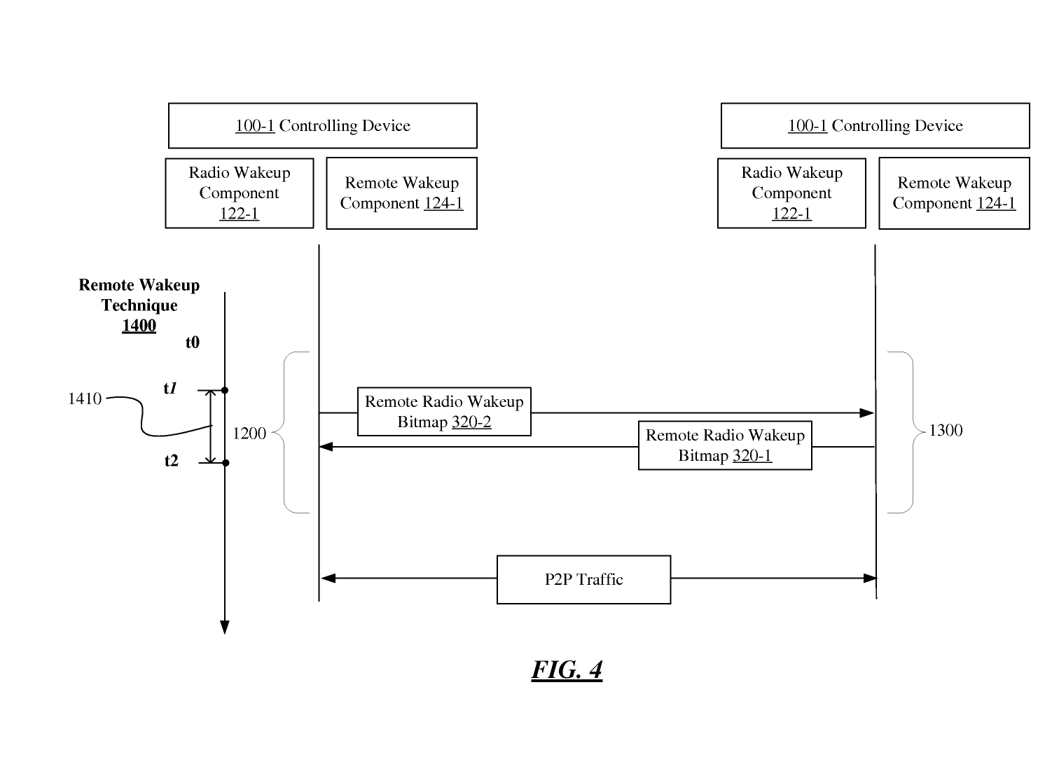

During operation, the devices 100-a may communicate signals (shown as Remote Wakeup Traffic 200) including indications of a request to wakeup a controlled device in order to communicate in the P2P network 1100. Based on these signals the controlled device 100-2 may “wakeup” from a sleep or low power state in order to communicate with the controlling device in the P2P network 1100. In particular, the controlling device 100-1 and the controlled device 100-2 may turn on their radios 112-a during a wakeup window (refer to FIG. 4) to communicate information regarding waking the controlled device 100-2 from the sleep or low power state. Based on these signals, the devices 100-a may fully power on in order to communicate in the P2P network 1100.

The radio wakeup component 122-a determines a wakeup window for communicating information including indications of a request to wakeup the controlled device 100-2. The radio wakeup component 122-a further may send a control directive to power on the radio 112-a during the wakeup window.

In some examples, the radio wakeup component 122-a determines the wakeup window based on time synchronization associated with a neighbor area network. More specifically, as will be appreciated, wireless devices (e.g., the devices 100-1 and/or 100-2) may organize into a neighbor area network (NAN) for purposes of advertising and/or communicating wirelessly with other devices. It is to be appreciated, that various NAN specifications exist, each with associated functionality and requirements. However, each NAN specification typically includes requirements to listen for NAN service advertisements and/or transmissions during a periodic window. Accordingly, with some examples, the radio wakeup component 122-a may determine the wakeup window based on the time synchronization of a NAN.

In some examples, the radio wakeup component 122-a may determine the wakeup window based on a beacon transmitted by Wi-Fi the access point 1001. For example, the radio wakeup component 122-a may determine the wakeup window based on a timestamp of the AP beacon 1002.

With some examples, the radio wakeup component 122-a may additionally determine a channel for communicating the remote wakeup traffic 200. More specifically, the radio wakeup component 122-a may determine the timing of the wakeup window as described above and may determine a channel to use during the wakeup window. In some examples, the radio wakeup component 122-a may use a preselected channel (e.g., Wi-Fi channel 6, or the like). In some examples, the radio wakeup component 122-a may determine the channel to use during the wakeup window based on the channel the Wi-Fi access point 1001 transmits the AP beacon 1002 on.

The remote wakeup component 124-a generates and/or receives a wakeup frame (refer to FIG. 4) for communication using the radio 112-a. For example, the remote wakeup component 124-1 may generate a wakeup frame including an indication of the controlled device 100-2. Additionally, the wakeup frame may include an indication of a control code corresponding to the controlled device 100-2. The remote wakeup component 124-2 may receive the wakeup frame.

In some examples, the wake up frame can use the format of a NAN Service Discovery frame (e.g., as described in Wi-Fi Alliance Technical Committee P2P Task Group, Wi-Fi Peer-to-Peer (P2P) Technical Specification, Version 1.2 2010). In such an example, the Service ID field in the NAN Service Discovery frame may be set to the value of Wi-Fi Control Service. The Subscribe bit of the Service Control field in the Service Descriptor attribute may be set to 1. The Matching Filter field of the Service Descriptor attribute may be set to the control code for the controlling device 100-2.

The controlled device 100-2 may then determine if it is the target of a wakeup frame based on the control code included in the wakeup frame. For example, the remote wakeup component 124-2 may determine whether the control code (e.g., the data in the Matching Filter field, or the like) corresponds with its own control code. The remote wakeup component 124-2 may then wakeup the controlled device 100-2 based on the determination that the control code in the remote wakeup frame matches the internal control code of the controlled device 100-2.

Accordingly, the controlling device 100-1 and the controlled device 100-2 may wakeup their radios 112-a at the same time (e.g., during the wakeup window) to communicate remote wakeup traffic 200 (e.g., wakeup frames). Based on the remote wakeup traffic 200, the controlled devices 100-2 may wakeup and/or exit a low power state. More specifically, the remote wakeup component 124-2 may send a control directive to wakeup the controlled device 100-2. In particular, the control code may cause one or more features and/or functionality of the controlled device 100-2 to be powered on.

In some examples, the remote wakeup component 124-2 may generate an awake frame including an indication that the controlled device 100-2 is awake and ready to communicate in the P2P network 1100. In some examples, the awake frame may be transmitted using the radio 112-2 and the antenna 132-2. Accordingly, an indication that the controlled device 100-2 is awake may be sent to the controlling device 100-1.

In some examples, awake frame may also use the format of a NAN Service Discovery frame. For example, the Service ID in the NAN Service Discovery frame may be set to the value of Wi-Fi Control Service. The Publish bit of the Service Control field in the Service Descriptor attribute may be set to 1. In further examples, a P2P Operation Attribute or a WLAN Infrastructure attribute can be included in the awake frame. As such, the controlled device 100-2 may communicate to the controlling device 100-1 various information regarding the P2P network 1100 and/or information necessary to connect to the controlled device 100-2.

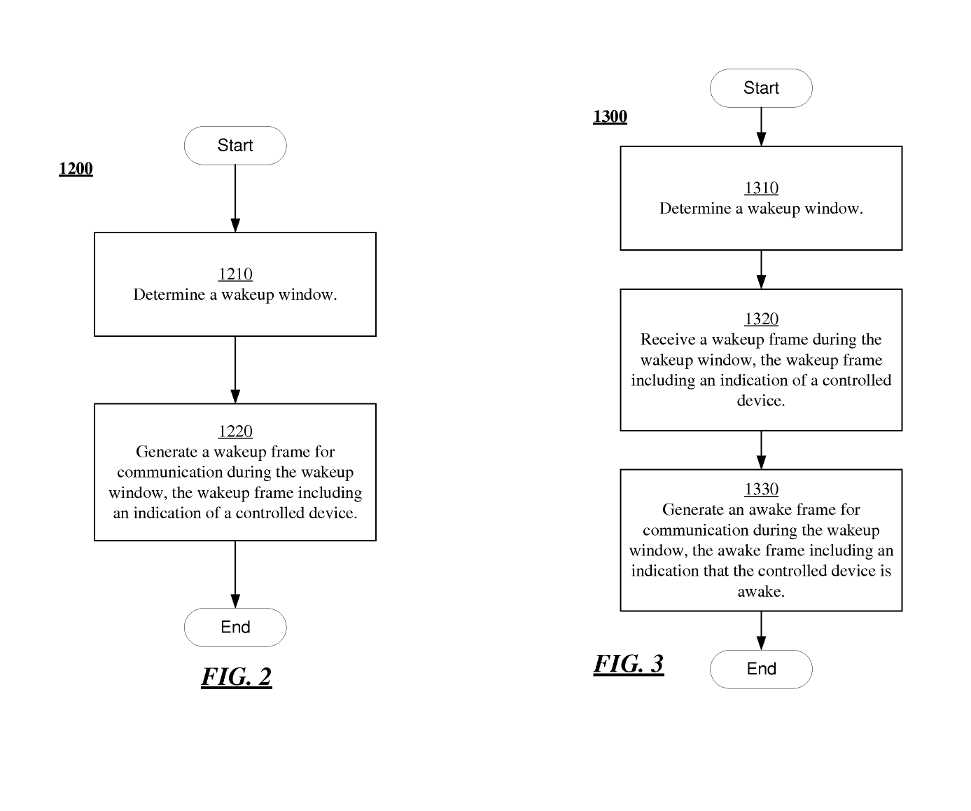

FIGS. 2-3 illustrate examples of logic flows representative of at least some operations executed by one or more logic, features, or devices described herein. In general, the logic flows may be representative of some or all of the operations executed by logic and/or features of the devices 100-a of the network 1000. In particular, FIG. 2 may be representative of operations performed by the controlling device 100-1 in remotely waking the controlled device 100-2 while FIG. 3 may be representative of operations performed by the controlled device 100-2 in remotely waking from a sleep or low power state. It is to be appreciated, that although the example logic flows are described with reference to the network 1000 of FIG. 1, this is not intended to be limiting and is merely done for clarity of presentation.

Turning more specifically to FIG. 2, a logic flow 1200 is depicted. The logic flow 1200 may begin at block 1210. At block 1210, “determine a wakeup window” the controlling device 100-1 may determine a wakeup window for communicating remote wakeup requests to a controlled device. In particular, the remote wakeup component 122-1 may determine the wakeup window (refer to FIG. 4) for communicating the remote wakeup traffic 200 with the controlled device 100-2.

Continuing to block 1220, “generate a wakeup frame for communication during the wakeup window, the wakeup frame including an indication of a controlled device” the controlling device 100-1 may generate the wakeup frame (refer to FIG. 4). In particular, the remote wakeup component 124-1 may generate the wakeup frame to include indications of the controlled device 100-2.

Turning more specifically to FIG. 3, a logic flow 1300 is depicted. The logic flow 1300 may begin at block 1310. At block 1310, “determine a wakeup window” the controlled device 100-2 may determine a wakeup window for receiving remote wakeup requests from a controlling device. In particular, the remote wakeup component 122-2 may determine the wakeup window (refer to FIG. 4) for communicating the remote wakeup traffic 200 with the controlling device 100-1.

Continuing to block 1320, “receive a wakeup frame during the wakeup window, the wakeup frame including an indication of a controlled device” the controlled device 100-2 may receive the wakeup frame from the controlling device 100-1. In particular, the remote wakeup component 124-2 may receive a wakeup frame (refer to FIG. 4) including an indication of a controlled device to be woken up.

Continuing to block 1330, “generate an awake frame for communication during the wakeup window, the awake frame including an indication that the controlled device is awake” the controlled device 100-2 may generate an awake frame. In particular, the controlled device 100-2 may generate the awake frame based on a determination that the control code indicated in the wakeup frame corresponds to an internal control code of the controlled device 100-2. The remote wakeup component 124-2 may generate the awake frame from communication received during the wakeup window.

FIG. 4 illustrates a remote wakeup technique 1400 that may be implemented by computing devices to remotely wake from a sleep or low power state. In some examples, the device 100-a may perform the technique 1400. In particular, the acts depicted in the technique 1200 may be representative of acts such as may be performed by the controlling device 100-1 and the controlled device 100-2 in order to remotely wake the controlled device 100-2 from a sleep or low power state.

In the technique 1400, communications are exchanged between the devices 100-1 and 100-2. In general, the controlling device 100-1 and the controlled device 100-2 may power their radios 112-a in a synchronized manner (e.g., during the wakeup window) to communicate the remote wakeup frame and the awake frame for purposes of establishing the P2P network 1100.

In particular, the technique 1400 shows the controlling device 100-1 communicating a remote wakeup frame 210 during a wakeup window 1410. As depicted, the wakeup window 1410 begins as time t1 and ends at time t2. It is to be appreciated; the times shown are shown for purposes of illustration only and are not intended to be to scale and/or limiting. However, as noted above, the radio wakeup component 122-a may determine the wakeup window (e.g., based on a NAN , based on an AP beacon, or the like). Accordingly, the time t1 may depend upon the particular implementation. The time t2 may depend upon a desired duration of the wakeup window. In general, the duration of the wakeup window 1410 may have any duration. In some embodiments, the wakeup window may have a duration between 1 and 128 micro seconds. Furthermore, the wakeup window may be repeating (e.g., periodically, or the like) with an interval for repeating the wakeup window of between 128 microseconds and 512 microseconds.

During the wakeup window 1410, the devices 100-a may power on their radios 112-a in order to communicate information regarding remotely waking up from a lower power or sleep state. In particular, the controlling device 100-1 may be configured to power on its radio 112-1 in order to communicate the wakeup frame 210 to the controlled device 100-2. In some examples, the controlling device 100-1 may be configured to perform the acts described in conjunction with the method 1200 during the technique 1400.

The controlled device 100-2 may be configured to power on its radio 112-2 in order to receive the remote wakeup frame 210. Additionally, the controlled device 100-2 may communicate the awake frame 220 based on receiving the remote wakeup frame 210. In particular, the controlled device 100-2 may be configured to power on its radio 112-2 during the wakeup window 1410 to receive the wakeup frame 210; exit a sleep or low power state based on receiving the wakeup frame 210; and transmit the awake frame 220. In some examples, the controlled device 100-2 may be configured to perform the acts described in conjunction with the method 1300 during the technique 1400.

As noted above, the remote wakeup frame 210 and the awake frame 220 may include indications of the controlled device 100-2 and the P2P network 1100. Accordingly, based on receiving the remote wakeup frame 210, the controlled device 100-2 may exit a sleep or low power state in order for the controlling device 100-1 and the controlled device 100-2 to establish and/or communicate in the P2P network 1100.

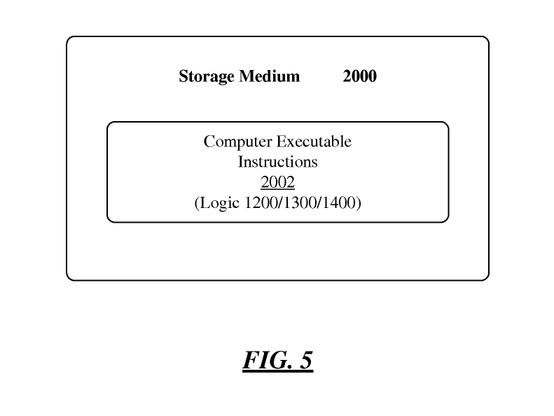

FIG. 5 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement logic flow 1200. In some examples, the storage medium 2000 may store various types of computer executable instructions to implement logic flow 1300. In some examples, the storage medium 2000 may store various types of computer executable instructions to implement acts associated with at least part of the technique 1400.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

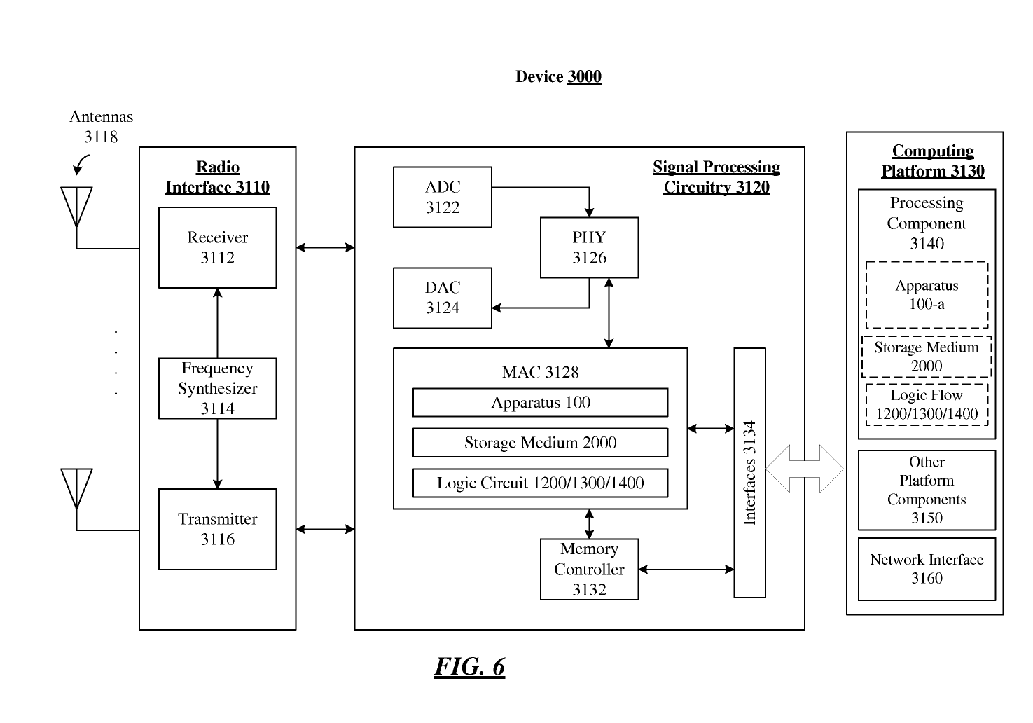

FIG. 6 illustrates an embodiment of a device 3000. In some examples, device 3000 may be configured or arranged for wireless communications in a P2P network such that the P2P network 1100 shown in FIG. 1. In some examples, one of the devices 100-a may be implemented in the device 3000. For example, the device 3000 may implement the device as apparatus 100-a. Additionally, the device 3000 may implement storage medium 2000 and/or a logic circuit 1200/1300/1400. The logic circuits may include physical circuits to perform operations described for the apparatus 100-a, storage medium 2000, logic flow 1200, logic flow 1300, and/or at least a portion of the logic flow 1400. As shown in FIG. 6, device 3000 may include a radio interface 3110, baseband circuitry 3120, and computing platform 3130, although examples are not limited to this configuration.

The device 3000 may implement some or all of the structure and/or operations for the apparatus 100-a, the storage medium 2000 and/or the logic circuit 1200/1300/1400 in a single computing entity, such as entirely within a single device. The embodiments are not limited in this context.

Radio interface 3110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 3110 may include, for example, a receiver 3112, a transmitter 3116 and/or a frequency synthesizer 3114. Radio interface 3110 may include bias controls, a crystal oscillator and antennas 3118-1 to 3118-f. In another embodiment, radio interface 3110 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 3120 may communicate with radio interface 3110 to process receive and/or transmit signals and may include, for example, an analog-to-digital converter 3122 for down converting received signals, a digital-to-analog converter 3124 for up converting signals for transmission. Further, baseband circuitry 3120 may include a baseband or physical layer (PHY) processing circuit 3126 for PHY link layer processing of respective receive/transmit signals. Baseband circuitry 3120 may include, for example, a processing circuit 3128 for medium access control (MAC)/data link layer processing. Baseband circuitry 3120 may include a memory controller 3132 for communicating with MAC processing circuit 3128 and/or a computing platform 3130, for example, via one or more interfaces 3134.

In some embodiments, PHY processing circuit 3126 may include a frame construction and/or detection module, in combination with additional circuitry such as a buffer memory, to construct and/or deconstruct communication frames (e.g., containing subframes). Alternatively or in addition, MAC processing circuit 3128 may share processing for certain of these functions or perform these processes independent of PHY processing circuit 3126. In some embodiments, MAC and PHY processing may be integrated into a single circuit.

Computing platform 3130 may provide computing functionality for device 3000. As shown, computing platform 3130 may include a processing component 3140. In addition to, or alternatively of, baseband circuitry 3120 of device 3000 may execute processing operations or logic for the apparatus 100a, storage medium 2000, and logic circuits 1100/1200/1300 using the processing component 3130. Processing component 3140 (and/or PHY 3126 and/or MAC 3128) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 3130 may further include other platform components 3150. Other platform components 3150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM

(EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 3130 may further include a network interface 3160. In some examples, network interface 3160 may include logic and/or features to support network interfaces operated in compliance with one or more wireless broadband technologies such as those described in one or more standards associated with IEEE 802.11 such as IEEE 802.11u or with technical specification such as WFA Hotspot 2.0.

Device 3000 may be part of a device in a P2P network and may be included in various types of computing devices to include, but not limited to, user equipment, a computer, a personal computer (PC), a desktop computer, a laptop computer, a notebook computer, a netbook computer, a tablet computer, an ultra-book computer, a smart phone, embedded electronics, a gaming console, a server, a server array or server farm, a web server, a network server, an

Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 2000 described herein; may be included or omitted in various embodiments of device 2000, as suitably desired. In some embodiments, device 2000 may be configured to be compatible with protocols and frequencies associated with IEEE 802.11 Standards or Specification and/or 3GPP Standards or Specifications for MIMO systems, although the examples are not limited in this respect.

The components and features of device 3000 may be implemented using any combination of discrete circuitry, application specific integrated circuits (ASICs), logic gates and/or single chip architectures. Further, the features of device 3000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 3000 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

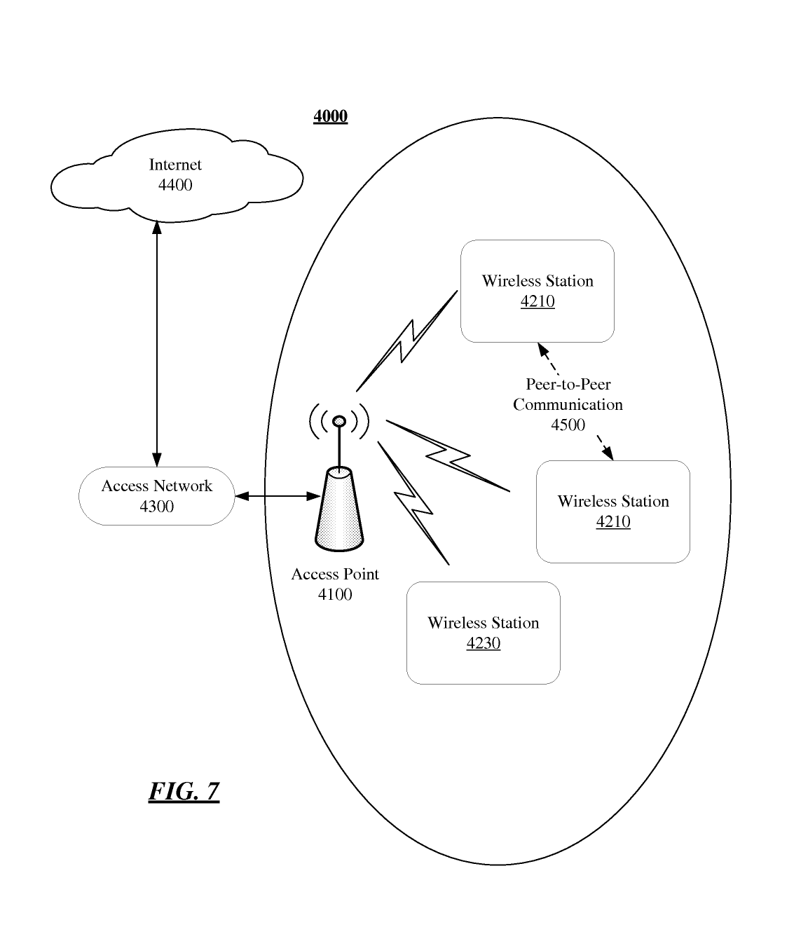

FIG. 7 illustrates an embodiment of a wireless network 4000. As shown in FIG. 7, wireless network 4000 comprises an access point 4100 and wireless stations 4210, 4220, and 4230. In various embodiments, wireless network 4000 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 4000 may comprise another type of wireless network, and/or may implement other wireless communications standards. In various embodiments, for example, wireless network 4000 may comprise a WWAN or WPAN rather than a WLAN. The embodiments are not limited to this example.

In various embodiments, wireless stations 4210, 4220, and 4230 may communicate with access point 4100 in order to obtain connectivity to one or more external data networks. In some embodiments, for example, wireless stations 4210, 4220, and 4230 may connect to the Internet 4400 via access point 4100 and access network 4300. In various embodiments, access network 4300 may comprise a private network that provides subscription-based Internet-connectivity, such as an Internet Service Provider (ISP) network. The embodiments are not limited to this example.

In various embodiments, two or more of wireless stations 4210, 4220, and 4230 may communicate with each other directly by exchanging peer-to-peer communications. For example, as depicted in FIG. 7, wireless stations 4210 and 4220 communicate with each other directly by exchanging peer-to-peer communications 4500. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WEDS) Task Group. In various embodiments, such peer-to-peer communications may be performed according to the MFA NAN protocol. The embodiments are not limited to these examples.

Various examples described herein may be provided to enable one or more of the wireless stations (e.g., the station 4210) to wake another of the wireless stations (e.g., the station 4220) in order to communicate in the peer-to-peer communication 4500. More specifically, one of the stations may be a controlling station (e.g., the controlling device 100-1) while another of the stations may be a controlled station (e.g., the controlled device 100-2). As such, the controlling device may wake the controlled device from a sleep or low power state as described herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other.

The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose might be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The detailed disclosure now turns to providing examples that pertain to further embodiments. The examples provided below are also not intended to be limiting.

Example 1: An apparatus for a device in a wireless network, the apparatus comprising circuitry; and a radio wakeup component executable by the circuitry, the radio wakeup component to determine a wakeup window for communicating information including an indication of a request to wakeup a controlled device in order to communicate in a peer-to-peer

(P2P) network with the controlled device, the radio wakeup component to determine the wakeup window based on a wireless network different than the P2P network.

Example 2: The apparatus of example 1, the radio wakeup component further to send a control directive to power on a radio during the wakeup window.

Example 3: The apparatus of example 1, the radio wakeup component further to determine a channel for the P2P network.

Example 4: The apparatus of example 1, further comprising a remote wakeup component executable by the circuitry, the remote wakeup component to generate a wakeup frame for communication using the radio, the wakeup frame including an indication of the controlled device.

Example 5: The apparatus of example 4, the wakeup frame further including an indication of a control code corresponding to the controlled device.

Example 6: The apparatus of example 4, the remote wakeup component further to receive awake frame from the controlled device, the awake frame including an indication that the controlled device is awake.

Example 7: The apparatus of example 1, further comprising a remote wakeup component executable by the circuitry, the remote wakeup component to receive a wakeup frame, the wakeup frame including an indication of the controlled device.

Example 8: The apparatus of example 7, the remote wakeup component further to determine whether the controlled device is the device in the wireless network based on the wakeup frame and to generate an awake frame based on the determination that the controlled device is the device in the wireless network.

Example 9: The apparatus of example 8, the wakeup frame further including an indication of a control code corresponding to the controlled device, the remote wakeup component to determine whether the control code matches a control code corresponding to the device in the wireless network.

Example 10: The apparatus of example 8, the remote wakeup component further to send a control directive to wakeup the device in the wireless network. Example 11: The apparatus of any one of examples 1 to 10, wherein the wakeup frame has the format of a neighbor area network service discovery frame.

Example 12: The apparatus of any one of examples 1 to 10, wherein the awake frame has the format of a neighbor area network service discovery frame.

Example 13: The apparatus of any one of examples 1 to 10, the radio wakeup component to determine the wakeup window based on a time synchronization associated with a neighbor area network.

Example 14: The apparatus of any one of examples 1 to 10, the radio wakeup component to determine the wakeup window based on a beacon transmitted by a Wi-Fi access point.

Example 15: The apparatus of any one of examples 1 to 10, the radio wakeup component to determine the channel based on a preselected channel.

Example 16: The apparatus of any one of examples 1 to 10, the radio wakeup component to determine the channel based on a channel associated with a beacon transmitted by a Wi-Fi access point.

Example 17: The apparatus of any one of examples 1 to 10, further comprising an antenna array operably coupled to the radio.

Example 18: The apparatus of any one of examples 1 to 10, the circuitry to comprise an application processor.

Example 19: The apparatus of any one of examples 1 to 10, the circuitry to comprise a baseband processor.

Example 20: A method implemented by a device in a wireless network, the method comprising determining a wakeup window for communicating information including an indication of a request to wakeup a controlled device in order to communicate in a peer-to-peer (P2P) network with the controlled device based on a wireless network different than the P2P network.

Example 21: The method of example 20, comprising sending a control directive to power on a radio during the wakeup window.

Example 22: The method of example 20, comprising determining a channel for the P2P network.

Example 23: The method of example 20, comprising generating a wakeup frame for communication using the radio, the wakeup frame including an indication of the controlled device.

Example 24: The method of example 23, the wakeup frame further including an indication of a control code corresponding to the controlled device.

Example 25: The method of example 23, comprising receiving an awake frame from the controlled device, the awake frame including an indication that the controlled device is awake.

Example 26: The method of example 20, comprising receiving a wakeup frame, the wakeup frame including an indication of the controlled device.

Example 27: The method of example 26, comprising determining whether the controlled device is the device in the wireless network based on the wakeup frame; and generating an awake frame based on the determination that the controlled device is the device in the wireless network.

Example 28: The method of example 27, the wakeup frame further including an indication of a control code corresponding to the controlled device, the method comprising determining whether the control code matches a control code corresponding to the device in the wireless network.

Example 29: The method of example 27, comprising sending a control directive to wakeup the device in the wireless network.

Example 30: The method of any one of examples 20 to 29, wherein the wakeup frame has the format of a neighbor area network service discovery frame.

Example 31: The method of any one of examples 20 to 29, wherein the awake frame has the format of a neighbor area network service discovery frame.

Example 32: The method of any one of examples 20 to 29, comprising determining the wakeup window based on a time synchronization associated with a neighbor area network.

Example 33: The method of any one of examples 20 to 29, comprising determining the wakeup window based on a beacon transmitted by a Wi-Fi access point.

Example 34: The method of any one of examples 20 to 29, comprising determining the channel based on a preselected channel.

Example 35: The method of any one of examples 20 to 29, comprising determining the channel based on a channel associated with a beacon transmitted by a Wi-Fi access point.

Example 36: At least one machine readable medium comprising a plurality of instructions that in response to being executed on a node in a wireless network cause the node to perform the method of any of examples 20 to 35.

Example 37: An apparatus for a wireless network comprising a processor; a radio operably connected to the processor; one or more antennas operably connected to the radio to transmit or receive wireless signals; and a memory comprising a plurality of instructions that in response to being executed by the processor cause the processor or the radio to perform the method of any of examples 20 to 35.

1.-25. (canceled)

26. An apparatus for a device in a wireless network, the apparatus comprising:
circuitry;
a radio wakeup component executable by the circuitry, the radio wakeup component to determine a wakeup window for communicating information including an indication of a request to wakeup a controlled device in order to communicate in a peer-to-peer (P2P) network with the controlled device, the radio wakeup component to determine the wakeup window based on a wireless network different than the P2P network.

27. The apparatus of claim 26, the radio wakeup component further to determine a channel for the P2P network.

28. The apparatus of claim 26, further comprising a remote wakeup component executable by the circuitry, the remote wakeup component to generate a wakeup frame for communication using the radio, the wakeup frame including an indication of the controlled device.

29. The apparatus of claim 28, the wakeup frame further including an indication of a control code corresponding to the controlled device.

30. The apparatus of claim 28, the remote wakeup component further to receive an awake frame from the controlled device, the awake frame including an indication that the controlled device is awake.

31. The apparatus of claim 26, further comprising a remote wakeup component executable by the circuitry, the remote wakeup component to receive a wakeup frame, the wakeup frame including an indication of the controlled device.

32. The apparatus of claim 31, the remote wakeup component further to determine whether the controlled device is the device in the wireless network based on the wakeup frame and to generate an awake frame based on the determination that the controlled device is the device in the wireless network.

33. The apparatus of claim 32, the wakeup frame further including an indication of a control code corresponding to the controlled device, the remote wakeup component to determine whether the control code matches a control code corresponding to the device in the wireless network.

34. The apparatus of claim 32, the remote wakeup component further to send a control directive to wakeup the device in the wireless network.

35. The apparatus of claim 30, wherein at least one of the wakeup frame and the awake frame has the format of a neighbor area network service discovery frame.

36. The apparatus of claim 26, the radio wakeup component to determine the wakeup window based on a time synchronization associated with a neighbor area network.

37. The apparatus of claim 27, the radio wakeup component to determine the wakeup window based on a beacon transmitted by a Wi-Fi access point and to determine the channel based on a channel associated with a beacon transmitted by a Wi-Fi access point.

38. The apparatus of claim 26, further comprising an antenna array operably coupled to the radio.

39. The apparatus of claim 26, the circuitry to comprise an application processor.

40. The apparatus of claim 26, the circuitry to comprise a baseband processor.

41. A method implemented by a device in a wireless network, the method comprising:
determining a wakeup window for communicating information including an indication of a request to wakeup a controlled device in order to communicate in a peer-to-peer (P2P) network with the controlled device based on a wireless network different than the P2P network; and
sending a control directive to power on a radio during the wakeup window.

42. The method of claim 41, comprising determining a channel for the P2P network.

43. The method of claim 41, comprising generating a wakeup frame for communication using the radio, the wakeup frame including an indication of the controlled device.

44. The method of claim 43, the wakeup frame further including an indication of a control code corresponding to the controlled device.

45. The method of claim 43, comprising receiving an awake frame from the controlled device, the awake frame including an indication that the controlled device is awake.

46. The method of claim 41, comprising receiving a wakeup frame, the wakeup frame including an indication of the controlled device.

47. At least one machine readable medium comprising a plurality of instructions that in response to being executed on a device in a wireless network cause the device to:
determine a wakeup window for communicating information including an indication of a request to wakeup a controlled device in order to communicate in a peer-to-peer (P2P) network with the controlled device;
send a control directive to power on a radio during the wakeup window;
determine whether the controlled device is the device in the wireless network based on the wakeup frame; and
generate an awake frame based on the determination that the controlled device is the device in the wireless network.

48. The at least one machine readable medium of claim 47, the wakeup frame further including an indication of a control code corresponding to the controlled device, the instructions further causing the device to determine whether the control code matches a control code corresponding to the device in the wireless network.

49. The at least one machine readable medium of claim 47, the instructions further causing the device to determine the wakeup window based on a time synchronization associated with a neighbor area network.

50. The at least one machine readable medium of claim 47, the instructions further causing the device to determine the wakeup window based on a beacon transmitted by a Wi-Fi access point.
